(19) United States
(12) Patent Application Publication
(10) Pub. No.: US 2011/0254456 A1
(43) Pub. Date: Oct. 20, 2011

(54) Current Balancing Circuit For LED Strings

(76) Inventor: Ti-Hua Ko, Taipei (TW)

(21) Appl. No.: 12/760,551

(22) Filed: Apr. 14, 2010

(51) Int. Cl. H05B 37/02

(52) U.S. Cl. 315/185 R

(57) ABSTRACT

A current balancing circuit includes a plurality of LED strings each formed by a series-connection of a plurality of LEDs, a current mirror module including the same number of tri-electrodes elements as that of the LED strings, and a constant-current source providing a constant current for the LED strings. Two electrodes of one of the tri-electrodes elements are short-connected with each other, and the tri-electrodes elements are further connected with one another through one short-connected electrode thereof so as to achieve a mirror effect. The tri-electrodes elements are further one-on-one series-connected with the corresponding LED strings respectively so as to make the LED strings equally distribute the constant current from the constant-current source on the basis of the mirror effect of the current mirror module.

### BACKGROUND OF THE INVENTION

1. Field of the Invention

The present invention generally relates to a current balancing circuit, and more particularly to a current balancing circuit for LED strings.

2. The Related Art

Referring to FIG. 1, a traditional current balancing circuit for LED strings includes a power supply module 10′, a plurality of LED strings 12′, a current mirror module 11′ and a driving module 13′. Each of the LED strings 12′ is formed by a series-connection of a plurality of LEDs D. The current mirror module 11′ includes the same number of first FETs DA1˜n as that of the LED strings 12′, and the driving module 13′ includes the same number of second FETs DB1˜n as that of the LED strings 12′ which are one-on-one connected between the corresponding first FETs DA1˜n and the corresponding LED strings 12′ respectively. The power supply module 10′ includes the same amounts of constant-current sources IB1˜n as that of the first FETs DA1˜n which are one-on-one connected with the corresponding first FETs DA1˜n to provide a current for the corresponding first FETs DA1˜n and further generate a voltage-driving signal to drive the corresponding second FETs DB1˜n. Then the second FET DB obtains the current from the corresponding first FET DA according to a mirror effect of the current mirror module 11′ and then drives the corresponding LED string 12′ to be lightened.

However, a plurality of constant-current sources IB and a plurality of FETs twice as many as the LED strings 12′ used in the traditional current balancing circuit result in a high cost and a drawback of current inconsistencies caused by the individual differences of various constant-current sources 10′. Moreover, it further causes an inaccuracy when changing the current of the LED strings 12′ with a slight range.

### SUMMARY OF THE INVENTION

An object of the present invention is to provide a current balancing circuit for LED strings. The current balancing circuit includes a plurality of LED strings each formed by a series-connection of a plurality of LEDs, a current mirror module including the same number of tri-electrodes elements as that of the LED strings, and a constant-current source providing a constant current for the LED strings. Two electrodes of one of the tri-electrodes elements are short-connected with each other, and the tri-electrodes elements are further connected with one another through one short-connected electrode thereof so as to achieve a mirror effect. The tri-electrodes elements are further one-on-one series-connected with the corresponding LED strings respectively so as to make the LED strings equally distribute the constant current from the constant-current source on the basis of the mirror effect of the current mirror module.

As described above, the current balancing circuit for LED strings of the present invention utilizes only the constant-current source to provide the constant current for the LED strings and utilizes the mirror effect of the current mirror module to make the currents flowing through the LED strings equal, so that achieves an equal distribution of the constant current and eliminates the drawbacks of current inconsistencies caused by the individual differences of many constant-current sources in the prior art. Moreover, it further improves the accuracy when changing the current of the LED string with a slight range.

### BRIEF DESCRIPTION OF THE DRAWINGS

The present invention will be apparent to those skilled in the art by reading the following description, with reference to the attached drawings, in which:

FIG. 1 is a circuitry of a conventional current balancing circuit for LED strings;

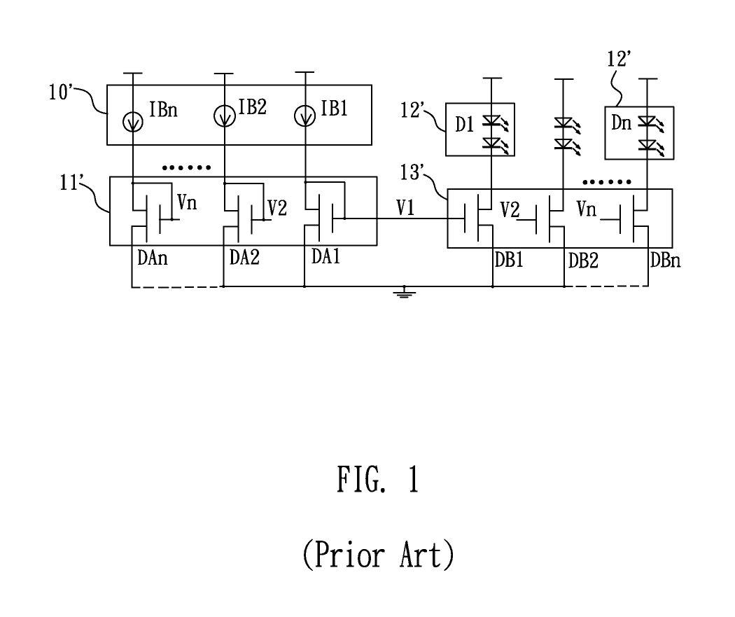

FIG. 2 is a circuitry of a current balancing circuit for LED strings according to a first embodiment of the present invention; and

FIG. 3 is a circuitry of a current balancing circuit for LED strings according to a second embodiment of the present invention.

### DETAILED DESCRIPTION OF THE PREFERRED EMBODIMENT

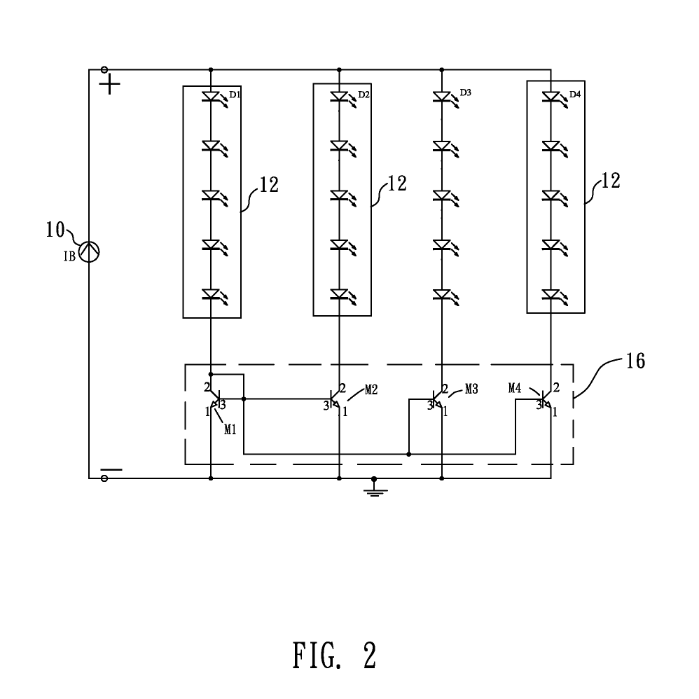

With reference to FIG. 2, a current balancing circuit for LED strings according to a first embodiment of the present invention includes a constant-current source 10, a plurality of LED strings 12 and a current mirror module 16. Each of the LED strings 12 is formed by a series-connection of a plurality of LEDs D. The current mirror module 16 includes the same number of tri-electrodes elements as that of the LED strings 12. In the first embodiment, transistors M1˜n are acted as the tri-electrodes elements.

The outmost anode of each LED string 12 is connected with the positive electrode of the constant-current source 10. The emitter of each transistor M of the current mirror module 16 is connected with the negative electrode of the constant-current source 10 and also connected to ground. The outmost cathodes of the LED strings 12 are one-on-one connected with the collectors of the corresponding transistors M1˜n of the current mirror module 16. The bases of the transistors M1˜n are connected with one another together, wherein the base of one of the transistors M1˜n is further short-connected with the collector thereof.

Because of a mirror effect of the current mirror module 16, the currents flowing through the collectors of the transistors M1˜n are equal to one another so that make the currents flowing through the LED strings 12 equal to one another too. Because only the constant-current source 10 is used to provide a constant current IB for all the LED strings 12, finally the constant current IB from the constant-current source 10 will be equally distributed for each LED string 12. For example, there are four LED strings 12 in the first embodiment of the present invention, so the current flowing through any one of the LED strings 12 is equal to quarter of the constant current IB. If the constant-current source 10 provides a constant current IB of 80 mA, each LED string 12 can obtain 20 mA current equally. If the constant-current source 10 provides a constant current IB of 100 mA, each LED string 12 can obtain 25 mA current equally.

The above comparison of current changes between the constant-current source 10 and the LED strings 12 demonstrates that: when the current flowing through each LED string 12 need to increase 5 mA from 20 mA, only an increase is needed that is the constant current IB of the constant-current source 10 from 80 mA to 100 mA. If the current of each LED string 12 needs to be regulated with a slight range, a great total value of current regulation can be achieved by the constant-current source 10 that can ensure an accurate current regulation of the constant-current source 10 and further ensure accurate and equal current changes of all the LED strings 12.

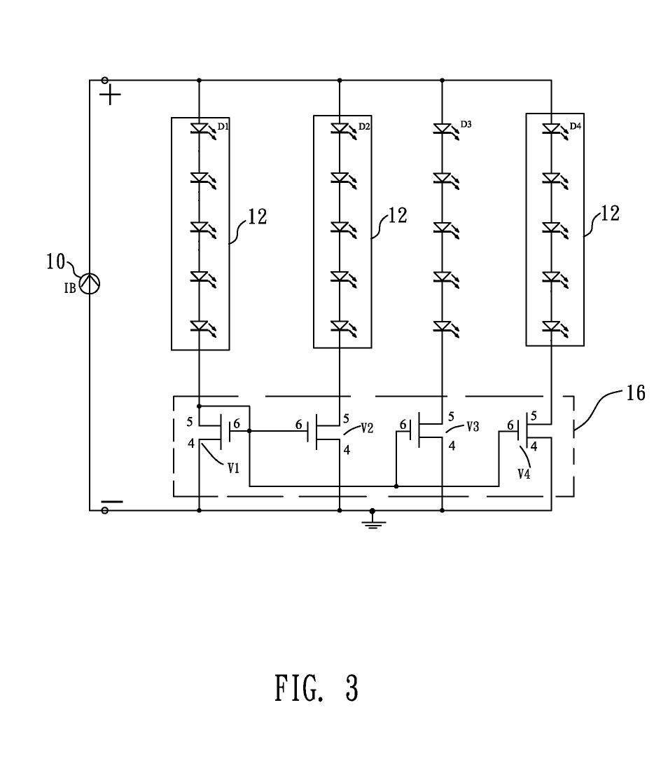

Referring to FIG. 3, a current balancing circuit for LED strings according to a second embodiment of the present invention is shown. Comparing to the first embodiment, the differences are that the current mirror module 16 includes the same number of FETs V1˜n as that of the LED strings 12 instead of the transistors M1˜n acted as the tri-electrodes elements. The sources of the FETs V1˜n are connected with the negative electrode of the constant-current source 10 and also connected to ground, the drains thereof are one-on-one connected with the outmost cathodes of the corresponding LED strings 12, and the grids thereof are connected with one another together, wherein the grid of one of the FETs V1˜n is further short-connected with the drain thereof.

As described above, the current balancing circuit for LED strings of the present invention utilizes only the constant-current source 10 to provide the constant current IB for the LED strings 12 and utilizes the mirror effect of the current mirror module 16 to make the currents flowing through the LED strings 12 equal, so that achieves an equal distribution of the constant current IB and eliminates the drawbacks of current inconsistencies caused by the individual differences of many constant-current sources IB in the prior art. Moreover, it further improves the accuracy when changing the current of the LED string 12 with a slight range.

What is claimed is:

1. A current balancing circuit for LED strings, comprising:
a plurality of LED strings each formed by a series-connection of a plurality of LEDs;
a current mirror module including the same number of tri-electrodes elements as that of the LED strings, two electrodes of one of the tri-electrodes elements being short-connected with each other, and the tri-electrodes elements being further connected with one another through one short-connected electrode thereof so as to achieve a mirror effect; and
a constant-current source providing a constant current for the LED strings, wherein the tri-electrodes elements are further one-on-one series-connected with the corresponding LED strings respectively so as to make the LED strings equally distribute the constant current from the constant-current source on the basis of the mirror effect of the current mirror module.

2. The current balancing circuit as claimed in claim 1, wherein a plurality of transistors are acted as the tri-electrodes elements of which the emitters are connected with the constant-current source, the collectors are one-on-one connected with the corresponding LED strings, and the bases are connected with one another together, the base of one of the transistors is further short-connected with the collector thereof.

3. The current balancing circuit as claimed in claim 1, wherein a plurality of FETs are acted as the tri-electrodes elements of which the sources are connected with the constant-current source, the drains are one-on-one connected with the corresponding LED strings, and the grids are connected with one another together, the grid of one of the FETs is further short-connected with the drain thereof.
